(19) United States
(12) Patent Application Publication
(10) Pub. No.: US 2025/0246665 A1
(43) Pub. Date: Jul. 31, 2025

(54) BATTERY MANUFACTURING METHOD AND BATTERY MANUFACTURING SYSTEM

(71) Applicant: LG Energy Solution, Ltd., Seoul (KR)

(72) Inventors: Min Kyu SIM, Daejeon (KR); Jee Yeon Koh, Daejeon (KR); Min Su Kim, Daejeon (KR); Jong Seok Park, Daejeon (KR); June Hee Kim, Daejeon (KR); Jong Kwon Shin, Daejeon (KR)

(21) Appl. No.: 18/606,685

(22) Filed: Mar. 15, 2024

(30) Foreign Application Priority Data
Jan. 29, 2024 (KR) 10-2024-0013083

(51) Int. Cl. H01M 10/04

(52) U.S. Cl. CPC H01M 10/0409; H01M 10/0431

(57) ABSTRACT

A battery manufacturing method according to an embodiment includes a first operation of acquiring pattern indicator data and measurement data and/or inspection data for an electrode sheet having patterns in which coated portions and uncoated portion are repeatedly arranged, and the pattern indicator data includes representing positions of the patterns at the electrode sheet; a second operation of associating the measurement data and/or inspection data with the pattern indicator data; and a third operation of generating inter-process monitoring data by matching the pattern indicator data for each process of a plurality of processes so as to correspond to a same physical position of the electrode sheet.

### TECHNICAL FIELD

The present disclosure relates to a battery manufacturing method and a battery manufacturing system.

The present application claims priority to Korean Patent Application No. 10-2024-0013083 filed in the Republic of Korea on Jan. 29, 2024, the disclosure of which is incorporated herein by reference.

### BACKGROUND

Unlike primary batteries, secondary batteries can be charged or discharged a plurality of times. The secondary batteries are widely used as energy sources for various wireless devices such as handsets, notebook computers, cordless vacuum cleaners, and the like. Recently, the manufacturing cost per unit capacity of a secondary battery has been significantly reduced due to improvements in energy density and economies of scale, and as the traveling distance of a battery electric vehicle (BEV) increases to the same level as that of a fuel vehicle, the main use of secondary battery is shifting from a mobile device to mobility.

A secondary battery is manufactured through an electrode process, an assembly process, and an activation process. Among the above processes, the electrode process is the most critical process in determining the yield and performance of battery cells. The electrode process may include a coating process, a roll pressing process, and a slitting process. In the coating process, a surface of a current collector may be coated with an active material and an insulating material. In the roll pressing process, an electrode may be pressed by pressing rolls. The roll pressing process may determine the density, performance, and surface quality of the electrode. In the slitting process, the electrode may be cut into a plurality of electrodes depending on the battery cell design.

### SUMMARY

The present disclosure directed to providing a battery manufacturing method and battery manufacturing system with improved quality traceability and data match in a battery manufacturing process using patterned electrodes.

An exemplary battery manufacturing method of the present disclosure for solving the above problems includes a first operation of acquiring pattern indicator data and measurement data and/or inspection data for an electrode sheet having patterns in which coated portions and uncoated portion are repeatedly arranged, and the pattern indicator data includes representing positions of the patterns at the electrode sheet, a second operation of associating the measurement data and/or inspection data with the pattern indicator data, and a third operation of generating inter-process monitoring data by matching the pattern indicator data for each process of a plurality of processes so as to correspond to a same physical position of the electrode sheet.

The pattern indicator data for each process is matched by at least one of the following: 1) as positions of start and end portions of the electrode sheet are inverted between the processes, matching between the processes is performed with the inverted pattern indicator data; 2) matching between the processes is performed with the pattern indicator data which changes depending on a loss at the electrode sheet that occurs during a process and/or between the processes; and 3) as a corresponding surface of the electrode sheet is inverted between the processes in a winding direction or an unwinding direction of the electrode sheet, matching between the processes is performed with the inverted pattern indicator data.

Operation 2) may include indicating the pattern indicator data as absolute for the pattern indicator data that includes at least one portion removed due to the loss from the electrode sheet; indicating the pattern indicator data as relative for the pattern indicator data that excludes the at least one portion removed due to the loss from the electrode sheet; and matching the relative pattern indicator data with the absolute pattern indicator data that does not include the at least one portion removed due to the loss from the electrode sheet.

Operation 2) may include associating a cell ID to a relative pattern indicator data in a final process among the processes.

The first operation may include acquiring coordinate data that indicates positions of the electrode sheet in succession, the second operation may include associating the measurement data and/or inspection data with the pattern indicator data and the coordinate data, and the third operation may include generating the monitoring data based on the pattern indicator data, the coordinate data, and the measurement data and/or inspection data associated with the pattern indicator data and the coordinate data.

The third operation may include at least one of the following operations: i) generating monitoring data using compressed measurement data and/or inspection data based of the pattern indicator data, the coordinate data, and the measurement data and/or inspection data; and ii) generating inter-process monitoring data by matching the pattern indicator data for each process and/or matching the coordinate data for each process so as to correspond to the same physical position of the electrode sheet.

The compressed measurement data and/or inspection data may include at least one of a representative value and/or a determination value of measurement values and/or inspection values of the measurement data and/or inspection data, and pattern indicator data and the coordinate data for starting and ending points of a portion of the electrode sheet in which the measurement data and/or inspection data are collected.

The pattern indicator data for each process may be matched or the coordinate data for each process is matched, by at least one of the following: 1) as positions of start and end portions of the electrode sheet are inverted between the processes, matching between the processes is performed with the inverted pattern indicator data; 2) matching between the processes is performed with the pattern indicator data and/or the coordinate data which changes depending on the loss of the electrode sheet that occurs during each process and/or between the processes; and 3) as a corresponding surface of the electrode sheet is inverted between the processes in a winding direction or an unwinding direction of the electrode sheet, matching between the processes is performed with the inverted pattern indicator data.

The pattern indicator data, the coordinate data, and the measurement data and/or inspection data may be associated with each other based on the same time or time section.

The monitoring data may include at least one of a roll map for each process that includes the pattern indicator data for each process and the measurement data and/or inspection data for each process associated with the pattern indicator data, and a roll map in which the pattern indicator data for each process is displayed to be matched with each other so as to correspond to the same physical position of the electrode sheet.

A battery manufacturing system as another aspect of the present disclosure includes a first position measuring instrument configured to generate pattern indicator data including representing positions of patterns on the electrode sheet in which coated portions and uncoated portion are repeatedly arranged, a measuring instrument and/or an inspecting instrument configured to collect measurement data and/or inspection data for the electrode sheet, and one or more processors configured to generate monitoring data for battery manufacturing based on the pattern indicator data and the measurement data and/or inspection data associated with the pattern indicator data, where the one or more processors are configured to generate inter-process monitoring data by matching the pattern indicator data for each process of a plurality of processes so as to correspond to a same physical position of the electrode sheet.

The system may include one or more processors configured to match the pattern indicator data for each process based on at least one of the following operations: Operation 1 of matching between the processes with inverted pattern indicator data as positions of start and end portions of the electrode sheet are inverted between the processes; operation 2 of matching between the processes with the inverted indicator data as a corresponding surface of the electrode sheet is inverted between the processes in a winding direction or an unwinding direction of the electrode sheet; and operation 3 of matching between the processes with the pattern indicator data which changes depending on a loss at the electrode sheet that occurs during a process and/or between the processes.

In operation 3, the one or more processors may be configured to indicate the pattern indicator data as absolute for the pattern indicator data that includes at least one portion removed due to the loss from the electrode sheet; indicate the pattern indicator data as relative for the pattern indicator data that excludes the at least one portion removed due to the loss from the electrode sheet; and match the relative pattern indicator data with the absolute pattern indicator data that does not include the at least one portion removed due to the loss from the electrode sheet.

Operation 3 may include associating a cell ID to a relative pattern indicator data in a final process among the processes.

The system may further include a second position measuring instrument configured to generate coordinate data that indicates positions of the electrode sheet in succession, wherein the one or more processors may generate the monitoring data for battery manufacturing on the basis of the pattern indicator data, the coordinate data, and the measurement data and/or inspection data associated with the pattern indicator data and the coordinate data, and the one or more processors may generate at least one of the following monitoring data: i) the monitoring data including compressed measurement data and/or inspection data based on the pattern indicator data, the coordinate data, and the measurement data and/or inspection data; and ii) the inter-process monitoring data generated by matching the pattern indicator data for each process and/or matching the coordinate data for each process so as to correspond to the same physical position of the electrode sheet.

The one or more processors may be configured to generate the compressed measurement data and/or inspection data by at least one of calculating a representative value and/or determining a determination value for measurement values and/or inspection values of respective measurement data and/or inspection data collected for pattern indicator data and the coordinate data of starting and ending points of a portion of the electrode sheet.

The one or more processors may be configured to associate the pattern data, the coordinate data, and the measurement data and/or inspection data with each other based on a same time or time section.

The system may further include a controller configured to control movement of the electrode sheet, where the association of the pattern indicator data with the measurement data and/or inspection data may be performed by the measuring instrument and/or inspecting instrument and/or the controller.

According to an exemplary embodiment, the system may further include a controller configured to control movement of the electrode sheet, where the association of the pattern indicator data and the coordinate data with the measurement data and/or inspection data may be performed by the measuring instrument and/or inspecting instrument and/or the controller.

The server system may include at least one of the following servers: i) a roll map generation server that generates a roll map for each process including the pattern indicator data for each process and the measurement data and/or inspection data for each process associated with the pattern indicator data; and ii) a roll map generation server that generates a roll map in which the pattern indicator data for each process is displayed to be matched with each other so as to correspond to a same physical position of the electrode sheet, as the inter-process monitoring data.

According to the present disclosure, monitoring data for battery manufacturing may be generated using position data (e.g., pattern indicator data, coordinate data) that may reflect pattern positions of electrodes with patterns. The battery manufacturing processes may be monitored to match the state of the physical patterned electrode, and thus quality traceability and data match may be improved.

Further, the present disclosure discloses generating monitoring data by compressing measurement data and/or inspection data. Therefore, resources of a server allocated to generating and storing the monitoring data may be reduced.

Further, the present invention discloses generating inter-process monitoring data by matching pattern disclosure data acquired in each process so as to correspond to a same physical position of the electrode sheet. Through the inter-process monitoring data, changes in electrode length between a plurality of processes or changes in the quality of each electrode may be intuitively identified to be matched with the position of the electrode. Further, when there is a problem with electrode quality, the problem may be tracked rapidly and easily.

Effects obtainable in exemplary embodiments of the present disclosure are not limited to the effects described above, and other effects that are not described may be clearly derived and understood by those skilled in the art from the following detailed descriptions to which the exemplary embodiments of the present disclosure pertain. That is, unintended effects resulting from implementing exemplary embodiments of the present disclosure may also be derived by those skilled in the art from the exemplary embodiments of the present disclosure.

### BRIEF DESCRIPTION OF THE DRAWINGS

FIG. 1 illustrates a battery manufacturing system according to an exemplary embodiment of the present disclosure.

FIGS. 2A and 2B illustrate a visualized roll map and patterned electrodes according to an exemplary embodiment of the present disclosure.

FIG. 3 is a flowchart for describing a battery manufacturing method according to an exemplary embodiment of the present disclosure.

FIG. 4 illustrates a roll map of a patterned electrode in which loading amount measurement data is arranged over time according to an exemplary embodiment of the present disclosure.

FIG. 5 shows inter-process monitoring data generated by a battery manufacturing method according to an exemplary embodiment of the present disclosure.

FIG. 6 is a schematic diagram illustrating a case in which a corresponding surface of an electrode sheet is inverted in an unwinding or winding direction of the electrode sheet according to an exemplary embodiment of the present disclosure.

FIG. 7 is a flowchart for describing a battery manufacturing method according to another exemplary embodiment of the present disclosure.

FIG. 8 illustrates a roll map of a patterned electrode on which pattern indicators and sub-pattern indicators are displayed according to an exemplary embodiment of the present disclosure.

FIGS. 9A and 9B show an example of a roll map in which pattern indicator data and coordinate data are displayed on a patterned electrode according to an exemplary embodiment of the present disclosure.

FIG. 10 shows inter-process monitoring data generated by a battery manufacturing method according to exemplary embodiments according to an exemplary embodiment of the present disclosure.

FIG. 11 illustrates a battery manufacturing system according to yet another exemplary embodiment of the present disclosure.

### DETAILED DESCRIPTION

Hereinafter, exemplary embodiments of the present disclosure will be described in detail with reference to the accompanying drawings. Prior to this, terms and words used in this specification and claims should not be interpreted as being limited to commonly used meanings or meanings in dictionaries and should be interpreted with meanings and concepts which are consistent with the technological scope of the present disclosure based on the principle that the inventors have appropriately defined concepts of terms in order to describe the present disclosure in the best way.

Therefore, since the embodiments described in this specification and configurations illustrated in the drawings are only exemplary embodiments and do not represent the overall technological scope of the present disclosure, it is understood that the present invention covers various equivalents and modifications that are substitutable at the time of filing of this application.

In addition, in the description of the present disclosure, when it is determined that detailed descriptions of related well-known configurations or functions unnecessarily obscure the gist of the present disclosure, the detailed descriptions thereof may be omitted.

Since the embodiments of the present disclosure are provided to more completely explain the present disclosure to those skilled in the art, the shapes and sizes of components in the drawings may be exaggerated, omitted, or schematically illustrated for clearer description. Therefore, the size or ratio of each component may not entirely reflect the actual size or ratio.

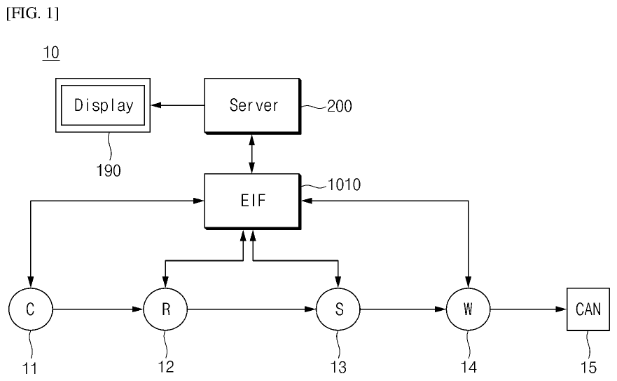

FIG. 1 illustrates a battery manufacturing system 10 according to an exemplary embodiment of the present disclosure.

Referring to FIG. 1, the battery manufacturing system 10 may include a coating device 11, a roll pressing device 12, a slitting device 13, a winding device 14, a relay server (event integration facility (EIF)) 1010, a server system 200, and a display device 190.

The battery manufacturing system 10 may be configured to manufacture battery cells (e.g., cylindrical battery cells, prismatic battery cells, or pouch cells) by performing a series of roll-to-roll processes. An electrode sheet unwound from a provided electrode roll may be processed by any one of a die coater of the coating device 11, pressing rolls of the roll pressing device 12, and a slitting knife of the slitting device 13, and the processed electrode sheet may be wound around the electrode roll. Accordingly, the processing of the coating device 11, the roll pressing device 12, and the slitting device 13 for production of electrodes of a battery may be referred to as a roll-to-roll process. The winding device 14 may wind a first electrode sheet (e.g., a negative electrode sheet) unwound from a first electrode roll (e.g., a negative electrode roll), a second electrode sheet (e.g., a positive electrode sheet) unwound from a second electrode roll (e.g., a positive electrode roll), and one or more separator sheets unwound from one or more separator rolls together.

The EIF 1010 may be a device for communication between process controllers of a manufacturing facility and the server system 200. The EIF 1010 may receive the process event data occurring in the coating device 11, the roll pressing device 12, the slitting device 13, and the winding device 14, and communicate the received process event data to the server system 200.

As necessary, each process controller and the server system 200 may communicate directly. Accordingly, process event data generated in the coating device 11, the roll pressing device 12, the slitting device 13, and the winding device 14 may each be transmitted to the server system 200.

The server system 200 may generate monitoring data for battery manufacturing. Representatively, the monitoring data may include a roll map including process event data. Data in the roll map may include data indicating a process event and coordinate values matched with the data. The coordinate values may represent positions on electrodes. The server system 200 may transmit a visualization command to the display device 190, and the display device 190 may visualize the roll map and display the visualized roll map (VRM).

The server system 200 may generate and store a roll map of each process (e.g., coating process, roll pressing process, or slitting process).

The roll map may be a type of a simulating electrode that imitates a moving real electrode (e.g., a real electrode moving between an unwinder and a rewinder).

Referring to FIG. 1 again, the electrode assembly manufactured by being wound by the winding device 14 may be transferred and accommodated in a case such as a can. A can ID, which is separate can ID information, may be assigned to the can, and the can ID may be a type of a battery cell ID. Therefore, historic data for the manufacture of battery cells may be retrieved based on the can ID.

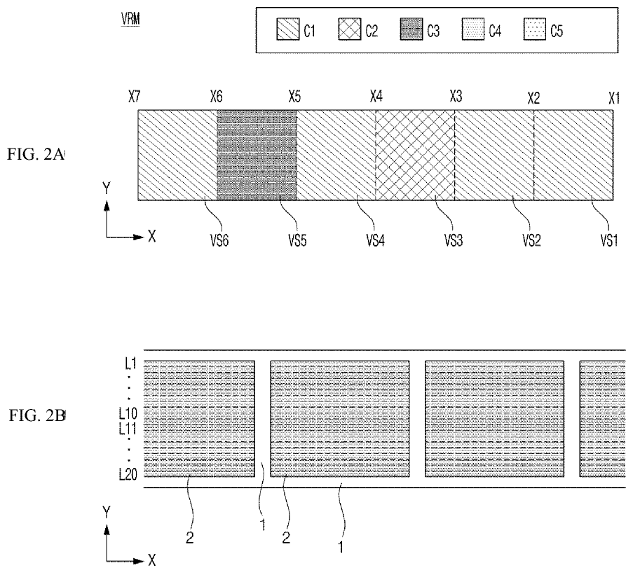

FIGS. 2A and 2B illustrate a visualized roll map and patterned electrodes according to an exemplary embodiment of the present disclosure.

In FIGS. 2A and 2B, arrow X indicates a longitudinal direction (moving direction) of an electrode sheet (roll map), and arrow Y indicates a width direction of the electrode sheet (roll map).

A visualized roll map (VRM) in FIG. 2A may include a plurality of visualization sections VS1, VS2, VS3, VS4, VS5, and VS6 corresponding to a plurality of sections of an electrode sheet. Each of the plurality of visualization sections VS1, VS2, VS3, VS4, VS5, and VS6 may include start coordinates, end coordinates, and color.

For example, a representative value of coordinate-related measurement data CMD of the visualization sections VS1, VS2, VS4, and VS6 may be displayed in color C1, a representative value of coordinate-related measurement data CMD of the visualization section VS3 may be displayed in color C2, and a representative value of coordinate-related measurement data CMD of the visualization section VS5 may be displayed in color C3.

For example, the color C1 may indicate that the representative value of the visualization sections VS1, VS2, VS4, and VS6 is normal, the color C2 may indicate that the representative value of the visualization section VS3 is excessive, and the color C3 may indicate that the representative value of the visualization section VS3 is very excessive. Color C4 may indicate that a representative value is insufficient, and color C5 may indicate that a representative value is very insufficient.

In this way, since the roll map expresses the position of the electrode in coordinates and can visualize measurement data (e.g., electrode slurry loading amount data) according to each position, the efficiency of electrode production management may be improved using the roll map and the data included therein.

FIG. 2B illustrates a patterned electrode sheet having patterns in which coated portions and uncoated portions are repeatedly arranged in the longitudinal direction.

The patterned electrode sheet may be slit in a width direction relative to the uncoated portion 1 between the coated portions 2 in the subsequent process. The slit coated portion 2 may be stacked with a coated portion of different polarity and separators so that an electrode assembly is formed, or may be wound together with separators and a coated portion of different polarity so that a jelly roll-shaped electrode assembly is formed.

In particular, patterned electrodes used for small batteries may be slit in a width direction and at the same time, slit in a longitudinal direction of the patterned electrode so that a plurality of electrode lanes L1 to L20 are formed.

Unlike a typical electrode in which coated portions are consecutively formed in a longitudinal direction, the patterned electrode has coated portions formed intermittently. Therefore, the roll map method as illustrated in FIG. 2A, which indicates the longitudinal positions of the electrode as length coordinates in succession, may not be suitable for the patterned electrodes. For example, the uncoated portions of the patterned electrode have loading amounts as measured values of 0, and are not significant portions that affect actual battery performance, and thus there may be no need to display these portions in detail by linking measurement data and coordinates. Further, the patterned electrodes are made into an electrode assembly according to the length and width of the coated portions 2 included in the pattern. That is, the electrode production result is counted as the number of coated portions 2 or the number of patterns including the coated portions 2. In this way, for the patterned electrode, it may be necessary to assign position data according to the characteristics of the patterned electrode, in which the electrode is produced and managed and the coated portions and the uncoated portions are intermittently formed, on the basis of the pattern. The present disclosure is to provide a battery manufacturing method and battery manufacturing system that may generate monitoring data on the basis of pattern indicator data, which may include position data suitable for the patterned electrode.

### First Embodiment

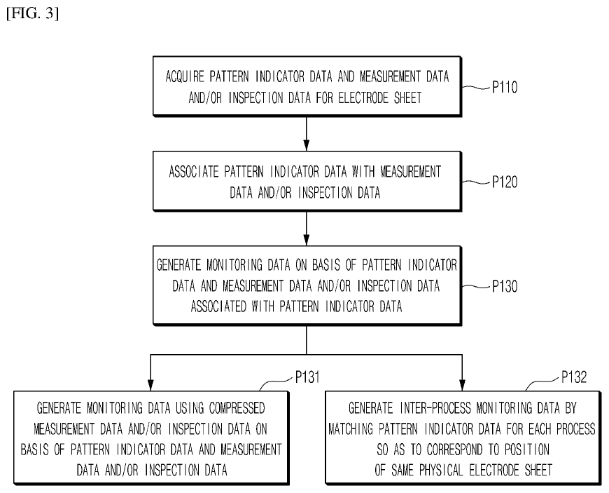

FIG. 3 is a flowchart for describing a battery manufacturing method according to an exemplary embodiment of the present disclosure.

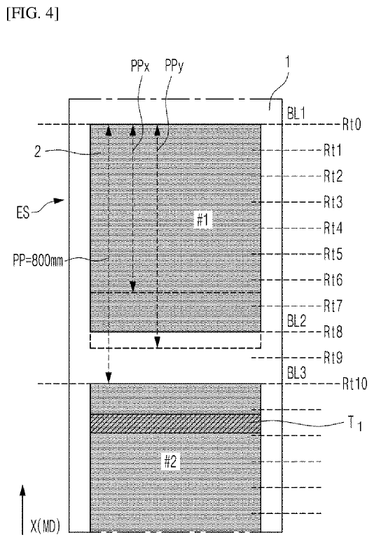

FIG. 4 illustrates a roll map of a patterned electrode in which loading amount measurement data is arranged over time according to an exemplary embodiment of the disclosure.

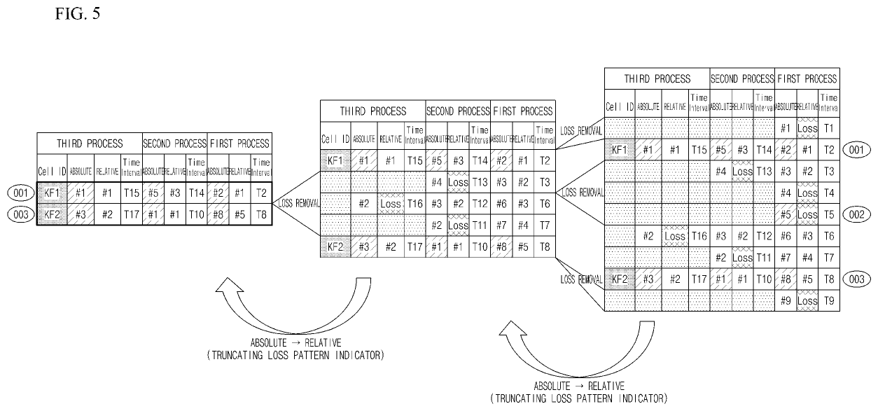

FIG. 5 shows inter-process monitoring data generated by a battery manufacturing method according to an exemplary embodiment of the present disclosure.

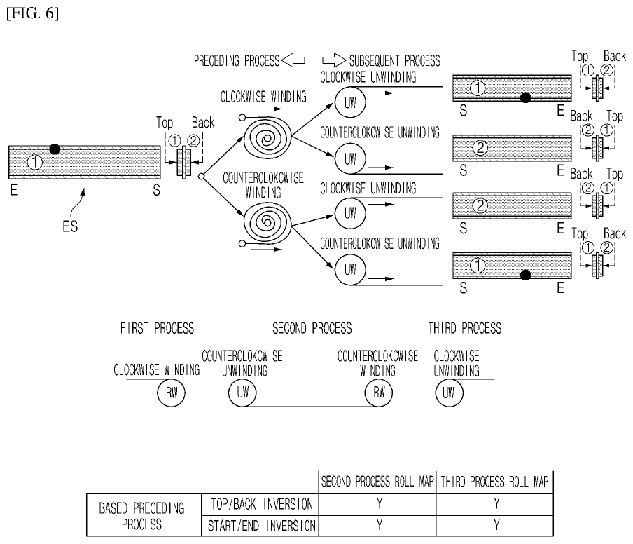

FIG. 6 is a schematic diagram illustrating a case in which a corresponding surface of an electrode sheet is inverted in an unwinding or winding direction of the electrode sheet according to an exemplary embodiment of the present disclosure.

Referring to FIG. 3, the battery manufacturing method of the present disclosure includes a first operation P110 of, when an electrode sheet having patterns in which coated portions and uncoated portion are repeatedly arranged moves in a plurality of processes, acquiring pattern indicator data indicating positions of the patterns on the electrode sheet and measurement data and/or inspection data for the electrode sheet.

As described above, the electrode sheet may move in the longitudinal direction in the plurality of processes (coating process, roll pressing process, slitting process, etc.) for producing a patterned electrode. The electrode sheet may move between an unwinder and a rewinder in each process. In this case, a first electrode roll on which the electrode sheet is wound may be loaded onto the unwinder. The electrode sheet unwound from the unwinder may move after a predetermined processing is performed, and be wound around the rewinder to form a second electrode roll. Alternatively, the electrode sheet may move in the longitudinal direction by a conveyor or other driving devices.

For the purpose of this disclosure, one pattern may refer to one coated portion 2 and one uncoated portion 1 consecutively from the coated portion 2. When a pattern indicator is assigned regarding only the coated portion or the uncoated portion as a pattern, the overall state of a patterned electrode may not be completely expressed. Referring to FIG. 2B, uncoated portions 1 are located on both sides of one coated portion 2. Therefore, one pattern may include one coated portion and an uncoated portion at one side of the coated portion, or one coated portion and an uncoated portion at the other side of the coated portion. The pattern indicator data may be acquired by counting the pattern number so that the pattern number increases or decreases for each pattern or identify differently using letters, characters, symbols, codes, or a combination of numbers and letters.

For example, the pattern indicator data may be pattern numbers assigned to each pattern. The pattern number may be counted by, for example, a pattern counter. Therefore, the pattern indicator data may be acquired by the pattern counter. Each counted pattern number may represent a position of the pattern on the moving electrode sheet. Accordingly, the pattern counter may be a position measuring instrument for measuring a position of the patterned electrode. When recognizing the start and end of a pattern, the pattern counter may count the pattern number of one pattern. However, it should be understood that the pattern counter may count the pattern number associated with a plurality of patterns. The pattern counter intermittently counts the pattern numbers. In other words, the pattern counter may count the patent number for one pattern or for a plurality of patterns. In this specification, the pattern counter that measures intermittent positions (pattern number) may be referred to as a first position measuring instrument. As will be described below, an encoder that measures consecutive positions (coordinates) may be referred to as a second position measuring instrument.

The length of one pattern may vary depending on the type or model of the patterned electrode. The length of one pattern specified for a specific patterned electrode may be referred to as a set pattern pitch. That is, the pattern pitch that is the sum of a set length of one coated portion and a set length of one uncoated portion may be referred to as a set pattern pitch.

When the length (pitch) of one pattern is different from the set pattern pitch, the pattern becomes a pattern with an abnormal pitch. According to an embodiment of the present disclosure, an operation of comparing the set pattern pitch with the length of each pattern to determine a pattern with an abnormal pitch may be further included.

The length of each pattern and/or the length of each of the coated portion and uncoated portion included in the pattern may be derived by multiplying differences in detection time points of boundary lines between the coated portions and the uncoated portions included in each pattern by a moving speed of the electrode sheet.

The pattern counter may include a pitch sensor and a trigger board. The pitch sensor may measure a length of each pattern, that is, a pitch of each pattern.

According to an exemplary embodiment, the pitch sensor may be a photoelectric sensor or include a photoelectric sensor. The photoelectric sensor consists of a light emitting unit and a light receiving unit. When light emitted from the light emitting unit is blocked or reflected by an object to be detected, an amount of light reaching the light receiving unit changes. The light receiving unit detects the change, converts the change into an electrical signal, and outputs the electrical signal. The amount of light emitted from the light emitting unit reaching the light receiving unit changes based on a boundary line between the coated portion 2 and the uncoated portion 1 on the patterned electrode. Accordingly, the pattern counter equipped with the pitch sensor may distinguish the coated portion 2 and the uncoated portion 1 on the patterned electrode. An optical fiber sensor may be used as the photoelectric sensor. The optical fiber sensor uses an optical fiber instead of a lens of the photoelectric sensor, and since the optical fiber, which is a detection part, has no electrical parts, there is an advantage of excellent environmental resistance such as noise resistance.

When the photoelectric sensor provided in the pitch sensor detects boundary lines between the coated portions and the uncoated portions, a detection time point of the boundary lines may be also recorded at the same time. Therefore, distances between the boundary lines may be obtained by multiplying the differences (time) in detection time points of the boundary lines between the coated portions and the uncoated portions included in each pattern by, for example, the moving speed of the electrode sheet. The pitch sensor or the pattern counter may include a calculation unit for calculating the time and speed.

A process of finding a pattern with an abnormal pitch using a pattern counter will now be described with reference to FIG. 4.

When the electrode sheet moves in a longitudinal direction X (moving direction MD), the pattern counter may detect boundary lines BL1, BL2, and BL3 of a coated portion and an uncoated portion.

BL1 denotes a boundary line between a first uncoated portion 1 at the top of FIG. 4 and a first coated portion 2 below the first uncoated portion 1. BL2 denotes a boundary line between the first coated portion and a second uncoated portion below the first coated portion. BL3 denotes a boundary line between the second uncoated portion and a second coated portion below the second uncoated portion.

For example, the pattern counter may count a pattern number to increase the pattern number by 1 when detecting the boundary lines BL1 and BL3 in each pattern.

The pattern counter may obtain a length of the first coated portion by multiplying a difference (time) between a BL1 detection time point and a BL2 detection time point by the moving speed of the electrode sheet.

The pattern counter may obtain a length of the second uncoated portion by multiplying a difference (time) between the BL2 detection time point and a BL3 detection time point by the moving speed of the electrode sheet.

The pattern counter may obtain a length (pitch) of a first pattern #1 by multiplying the difference (time) between the BL1 detection time point and the BL3 detection time point by the moving speed of the electrode sheet. In the same way, the pattern counter may obtain a length of a second pattern #2.

Further, a pattern with an abnormal pitch (length) may be determined by comparing the length of the pattern with a set pattern pitch PP. In FIG. 4, PPx denotes a pattern with an abnormal pitch smaller than the set pattern pitch PP. PPy denotes a pattern with an abnormal pitch greater than the set pattern pitch PP. For example, a pattern that has a large difference from the set pattern pitch may be determined as an abnormal pattern. The electrode portion with the abnormal pattern may be removed in a subsequent process.

The pitch sensor may transmit the length of the detected pattern to the trigger board. The trigger board may generate count information for each pattern on the basis of the length of each pattern received from the pitch sensor. That is, the trigger board may increase a count value for each length of each received pattern. For example, the trigger board may increase a binary coded decimal (BCD) code by 1 whenever the count value for each length of each pattern increases. The trigger board may convert the count value for each length of the generated pattern into a BCD code form and transmit the BCD code form to a controller of each process or a server of the battery manufacturing system. For example, the pattern counter (trigger board) may count the pattern number so that the pattern number increases for each pattern (so-called ascending order). Alternatively, the pattern counter (including trigger board) may count the pattern number so that the pattern number decreases for each pattern (so-called descending order). However, these are not only the count methods. It is understood that the pattern counter is able to indicate using pattern indicators so that the position of the pattern may be specified in some way. A pattern indicator may be numbers, letters, characters, symbols, codes, and/or a combination of numbers and letters.

Electrode specification data ESD may include model information, a recipe, and a pattern pitch of the electrode sheet. The electrode specification data ESD may include all matters related to the processing of the electrode sheet, such as process conditions including the number of lots processed in the current process, the number of coating lanes formed on the electrode sheet, temperature, humidity, and pressure, etc., process parameters including the moving speed of the electrode sheet, the discharge amount of coating die, the pressure of pressing rolls, etc., and the like. The electrode specification data ESD may be stored in the controller of each process or a server system. The pattern counter may download information about the set pattern pitch from the controller or server system and find a pattern with an abnormal pitch.

Measurement data and/or inspection data may be acquired for the electrode sheet. The measurement data and/or inspection data may refer to data that may be obtained through measurement or inspection of patterned electrodes. The measurement data and the inspection data may be acquired by the measuring instrument and the inspecting instrument that measure and inspect electrodes.

The measurement data may include measurement results expressed in numbers. For example, the measurement data may include dimensional data for electrode sheets such as a thickness and a width, loading amount data for coating materials on electrode sheets, mismatching data between coated portion lanes on a top side of an electrode sheet and coated portion lanes on a back side of the electrode sheet, and the like. As a non-limiting example, the measuring instrument may be either a web gauge or a thickness measuring instrument made by Thermo Fisher Scientific Inc.

The inspection data may include judgments and process events regarding the quality of portions of the electrode sheet. For example, the inspection data may include data for the appearance of electrode sheets collected by an image-based inspecting instrument, such as a vision machine, data for disconnections and seams of electrode sheets, data for a portion of the electrode sheet on which the sampling inspection is performed, data for a portion of the electrode sheet scheduled for scrap, data for reference points indicating the position of the electrode sheet, and defect data such as pinhole defects, crater defects, and line defects, etc. The inspecting instrument may be any one of a color sensor, a seam sensor, a reference point sensor, and a vision machine.

The pattern indicator data, the measurement data, the inspection data, and coordinate data, to be described below, may be time series data. The pattern indicator data may include pattern indicators, and data regarding a time or time section at which the pattern indicators are acquired. The time or time section may match with the pattern indicator.

The measurement data and/or inspection data may include measurement values and/or inspection values, and data regarding a time or time section at which the measurement values and/or the inspection values are acquired. The time or time section may match with the measurement values and/or inspection values.

That is, the pattern indicators, the coordinate values of the coordinate data, the measurement values, and inspection values may be arranged over time.

Therefore, the pattern indicator data, the coordinate data, and the measurement data and/or inspection data may be associated with each other based on the same time or time section at which each piece of data is acquired.

Referring to FIG. 3, the battery manufacturing method of the present disclosure may include a second operation P120 of associating the pattern indicator data with the measurement data and/or inspection data.

For example, the pattern indicators of the pattern indicator data and the measurement values and/or the inspection values may be associated with each other based on the same time or time section.

Referring now to FIG. 4, loading amounts Rt0 to Rt10 of the coating materials measured at each of measurement time points t0 to t10 are shown.

The boundary line BL1 between the coated portion and the uncoated portion is detected at a time point t0, the boundary line BL2 at a time point t8, and the boundary line BL3 at a time point t10, by the pattern counter. The loading amounts measured at the times t0, t8, and t10 are Rt0, Rt8, and Rt10, respectively. Loading amount measurement times of a pattern of pattern number #1 are t0, t1, t2, t3, t4, t5, t6, t7, t8, t9, and t10. Loading amount measurement values that correspond to the pattern of pattern number #1 and correspond to the times are Rt0, Rt1, Rt2, Rt3, Rt4, Rt5, Rt6, Rt7, Rt8, Rt9, and Rt10.

Further, the loading amounts Rt0 to Rt8 measured in sections between the times t0 to t8 are the measurement values associated with the coated portion between the boundary lines BL1 and BL2. Further, the loading amounts Rt8, Rt9, and Rt10 measured in sections between the times t8 to t10 are the measurement values associated with the uncoated portion between the boundary lines BL2 and BL3.

Therefore, based on the same sections between the times t0 to t10, the patterned electrode of pattern number #1 may be associated with the loading amounts Rt0 to Rt10.

Further, starting and ending points of connecting tape T₁ located on the coated portion of pattern number #2 may be detected by the seam sensor. Seam measurement data includes a seam measurement signal and a starting point measurement time and an ending point measurement time. In this case, the seam measurement data may be associated with a pattern of pattern number #2, which matches the same time as the starting and ending points at which the connecting tape T₁ is detected.

As described above, the pattern counter may obtain a length of each pattern and lengths of the coated portion and the uncoated portion belonging to each pattern by multiplying differences in time points at which the boundary lines are detected between the coated portion and the uncoated portion by the moving speed of the electrode sheet. By the same principle, when there is an appropriate computational tool, the computational tool may obtain the length of the coated or uncoated portion corresponding to each measurement section by multiplying the differences (time) in times at which the measurement values are obtained by the moving speed of the electrode sheet. The computational tool may be provided in, for example, a pattern counter, a process controller, a measuring instrument, or an inspecting instrument.

The association of the pattern indicator data with the measurement data and/or inspection data may be performed in the controller of the corresponding processing process in which the electrode sheet is processed. In this case, the measurement data and/or inspection data acquired by the measuring instrument and/or inspecting instrument may be transmitted to the controller, and the pattern indicator data acquired by the pattern counter may also be transmitted to the controller. The controller may associate the measurement data and/or inspection data acquired at the same time or time section with the pattern indicators of the pattern indicator data.

Alternatively, the association of the pattern indicator and the measurement data and/or inspection data may be performed in the measuring instrument and/or inspecting instrument. In this case, the pattern indicator data acquired by the pattern counter may be transmitted to the measuring instrument and/or inspecting instrument directly or through the controller. The measuring instrument and/or inspecting instrument may associate the measurement data and/or inspection data acquired at the same time or time section with the pattern indicators of the pattern indicator data.

Referring to FIG. 3, the battery manufacturing method of the present disclosure includes an operation P130 of generating monitoring data for battery manufacturing on the basis of the pattern indicator data, and the measurement data and/or inspection data associated with the pattern indicator data.

As described above, by assigning the pattern indicators to the patterned electrode, the position and indicator of patterns of the patterned electrode may be easily specified. As a result, the production result of the patterned electrode may be easily determined. Further, by associating the measurement data and/or inspection data acquired for the pattern electrode with the pattern indicator data, it may be possible to easily determine the state of each pattern, whether the electrode is broken, whether the electrode is defective, or the like. The roll map is one of the monitoring data in the electrode manufacturing process. As illustrated in FIG. 4, the roll map for the patterned electrode may include the pattern indicator data including the pattern indicators, and the measurement data or the inspection data associated with the pattern indicators. The measurement data and/or inspection data are a type of process event data that is generated in each process. The roll map is cumulatively generated for work pieces, parts, semi-finished products, and products of unit processes, thereby enabling tracking of process history for shipped products (e.g., battery cells, battery modules, or battery packs). For instance, the shipped products may include cell IDs that may be used to enable tracking of the process history should a need arise.

Referring to FIG. 3, the generating of the monitoring data may include at least one of the following operations:
i) an operation P131 of generating the monitoring data using compressed measurement data and/or inspection data on the basis of the pattern indicator data and the measurement data and/or inspection data; and
ii) an operation P132 of generating inter-process monitoring data by matching the pattern indicator data for each process so as to correspond to a position of the same physical electrode sheet.

As illustrated in FIG. 4, a plurality of measurement values may be assigned for one pattern. In FIG. 4, 10 measurement values are associated per pattern, but depending on the type of measuring instrument or inspecting instrument, a large number of measurement values and/or inspection values may be associated. In this way, when the size of measurement data and/or inspection data increases, a load is applied to the server system for generating the monitoring data. This may slow down data processing speed. The measurement data and/or inspection data may be compressed to reduce data size and increase a data processing speed.

For example, a processing unit provided in the measuring instrument and/or inspecting instrument may be configured to generate the compressed measurement data and/or inspection data on the basis of the pattern indicator data and the measurement data and/or inspection data. The compressed measurement data and/or inspection data has a smaller size than the measurement data and/or inspection data associated with the pattern indicator data. The resources of the server for generating the monitoring data may be reduced due to the compressed measurement data and/or inspection data.

The compressed measurement data and/or inspection data may include a representative value of the measurement values and/or inspection values of the measurement data and/or inspection data, and pattern indicator data for starting and ending points of a portion of the electrode sheet in which the measurement data and/or inspection data are collected. The compressed measurement data may further include a time stamp indicating the collection date and time of the measurement data and/or inspection data for each pattern or plurality of patterns, a measuring instrument and/or inspecting instrument ID, and a facility ID.

For example, the processing unit of the measuring instrument and/or inspecting instrument may calculate a representative value of the measurement data and/or inspection data for each pattern of the electrode sheet. The representative value may include at least one of an average, a standard deviation, a median, a maximum value, and a minimum value of the measurement data and/or inspection data of each pattern.

For example, when loading amount data corresponding to pattern number #1 has 10 measurement values corresponding to one scanning of the loading amount measuring instrument, the compressed measurement data may include a single representative value calculated based on the 10 measurement values. Accordingly, the size of the compressed measurement data may be smaller than the size of the measurement data associated with the pattern indicator data. In this case, the representative value may indicate a plurality of patterns in addition to indicating one pattern. That is, a single representative value may be acquired by grouping the plurality of patterns into groups and compressing the measurement data and/or inspection data acquired for each group. In this case, among the measurement values included in each pattern, the measurement values less than a certain value may be regarded as, for example, values measured in the uncoated portion of the corresponding pattern and excluded when calculating the representative value. That is, the representative value may be calculated from the measurement values included in each pattern that are greater than or equal to the certain value.

The pattern indicators of the starting and ending points of each pattern of the electrode sheet in which the measurement data and/or inspection data are collected may be determined based on the pattern indicator data. Alternatively, the pattern indicator of the starting and ending points of a portion of the electrode sheet corresponding to the plurality of patterns grouped by group may be determined. The pattern indicators of the starting and ending points of the compressed measurement data and/or inspection data may be substantially the same as the pattern indicators of the starting and ending points of the measurement data and/or inspection data associated with the pattern indicator data.

The measurement data and/or inspection data may be processed according to a set method, and thus the determination values for each pattern or plurality of patterns of the electrode sheet may be determined. When the measurement amount of coating materials on the electrode sheet (e.g., loading amount on the electrode sheet or thickness of the electrode sheet) is within a set range including upper and lower limits, the corresponding portion of the electrode sheet may be determined to be a good product. When the measurement amount is smaller than the lower limit or greater than the upper limit, the corresponding portion of the electrode sheet may be determined to be defective.

The processing unit may be configured to transmit the compressed measurement data and/or inspection data to the server system directly or through the process controller.

The server system or a server (e.g., manufacturing execution system (MES)) included in the server system may generate monitoring data (e.g., roll map) including the compressed measurement data and/or inspection data. In addition to generating the roll map, the MES performs various tasks to manage battery production. Therefore, when the roll map is generated based on the compressed measurement data and/or inspection data, the resources of the MES allocated to generating and storing the roll map may be reduced.

FIG. 5 shows inter-process monitoring data generated by a battery manufacturing method according to an exemplary embodiment of the present disclosure.

FIG. 6 is a schematic diagram illustrating a case in which a corresponding surface of an electrode sheet is inverted in an unwinding or winding direction of the electrode sheet according to an exemplary embodiment of the present disclosure.

The monitoring data may include a roll map for each process, which includes pattern indicator data for each process and measurement data and/or inspection data for each process associated with the pattern indicator data. As illustrated in FIG. 1, the roll map may be generated for each of a plurality of processes. For example, when a first process (coating process), a second process (roll pressing process), and a third process (slitting process) are performed sequentially, a roll map may be generated for each process. The roll map may be present not only in a form that replicates the electrode sheet as illustrated in FIG. 2A, but also in various forms that may visually display data on the roll map, such as graphs and diagrams.

As described above, the electrode sheet goes through a plurality of roll-to-roll processes, and the roll map may be generated for each roll-to-roll process.

However, due to the characteristics of the roll-to-roll process, an end portion of the electrode sheet wound in the first process (preceding process, for example, coating process) becomes a start portion when it is unwound in the second process (subsequent process, for example, roll pressing process). That is, the start and end portions of the electrode sheet are inverted between the processes. For this reason, the pattern indicator data acquired in each process is also inverted between the processes.

Further, the electrode sheet goes through a plurality of processes and is removed during each process and/or between the processes. Depending on the loss of the electrode sheet, the corresponding position of the electrode sheet corresponding to the pattern indicator data acquired in each process may vary.

Further, depending on a winding direction or an unwinding direction of the electrode sheet, a corresponding surface of the electrode sheet may be inverted between the processes. For example, a top side of the electrode sheet in the first process (preceding process, for example, coating process) may be inverted to a back side in the second process (subsequent process, for example, roll pressing process).

Due to the start-to-end inversion, occurrence of electrode sheet loss, and electrode sheet surface inversion, the pattern indicator data corresponding to a position of the same electrode sheet becomes inconsistent between the plurality of processes. In this case, even when the roll map, which is monitoring data, is generated for each process, it is difficult to compare the roll maps of each process in the same dimension, making it difficult to track the cause of problems occurring in the electrode sheet.

Referring to FIG. 3, according to an exemplary embodiment, the generating of the monitoring data may further include the operation P132 of generating the inter-process monitoring data by matching the pattern indicator data of each process so as to correspond to the position of the same physical electrode sheet.

FIG. 5 shows the process of generating the inter-process monitoring data by matching each piece of pattern indicator data of the first to third processes, reflecting the start-to-end inversion of the electrode and electrode loss.

In FIG. 5, in addition to the pattern indicator data, a time section in which the corresponding pattern indicator data is acquired is also shown.

In electrodes with pattern numbers #1 to #9 in the first process, the pattern indicators are arranged in inverted order in the second process. Further, the pattern indicators in the second process are arranged in inverted order in the third process. Since the positions of the start and end portions of the electrode sheet are inverted between the processes, in order to compare the data of each process at the position of the same physical electrode sheet, it may be necessary to match the inverted pattern indicator data as shown in FIG. 5.

Further, FIG. 5 shows the portions removed in each process. When the pattern indicator data is shown including the portion removed due to loss in each process, it is indicated as “absolute,” and when the pattern indicator data is shown excluding the removed portion, it is indicated as “relative.” When the pattern indicator data is regarded as types of coordinates indicating an intermittent position, “absolute” may be seen as “absolute coordinates” and “relative” may be seen as “relative coordinates.” In the electrode sheet, processing is performed to remove portions that are defective during each process, broken, etc., or to delete portions of uneven quality between the processes. In FIG. 5, in consideration of the loss of the electrode sheet that occurs during each process and/or between the processes, matching between the processes is performed with the pattern indicator data.

For example, in the first process, only pattern indicator data #2, #3, #6, #7, and #8 among “absolute pattern indicator data” #1 to #9 remain in consideration of the loss that occurs during the process. When this data is corrected with “relative pattern indicator data,” it becomes #1 to #5. That is, “absolute pattern indicator” #2 in the first process corresponds to “relative pattern indicator” #1. These pattern indicators are acquired at the same time section T2. In this way, by reflecting the loss in each process and considering the inversion of the start and end portions between the processes, the pattern indicator data corresponding to the position of the same physical electrode sheet may be matched in each process.

Cell IDs KF1 and KF2 may be assigned to battery cells manufactured from the surviving electrodes that are finally remaining through the first to third processes. In this case, pattern indicator data for each process corresponding to each cell ID is the same as shown in the leftmost diagram of FIG. 5.

Further, the pattern indicator data for each process is associated with the measurement data and/or inspection data, as illustrated in FIG. 4. Therefore, by selecting a specific pattern indicator with reference to a roll map or data included in the roll map, measurement data and/or inspection data corresponding to the pattern indicator may be identified. For example, in FIG. 5, the measurement data and/or inspection data for each process associated with the pattern indicators corresponding to the cell IDs KF1 and KF2 may be intuitively identified.

FIG. 6 shows that a surface of an electrode sheet is inverted between the processes depending on a winding direction or an unwinding direction of the electrode sheet according to an exemplary embodiment of the present disclosure.

In FIG. 6, an electrode sheet ES is a double-sided electrode sheet provided with coating materials on both surfaces.

A start portion of the electrode sheet is indicated by S and an end portion is indicated by E. A top side of the electrode sheet is marked as \textcircled{1} and a back side as \textcircled{2}, and a black dot is marked on the top side \textcircled{1} for comparison. There are four cases in which an electrode roll manufactured by being wound by a rewinder in a preceding process is unwound by an unwinder in a subsequent process. In all four cases, an inversion occurs in which the start and end portions of the electrode sheet are inverted between the preceding process and subsequent process.

For example, when a winding direction of the rewinder in the preceding process is an upward direction (clockwise winding) and an unwinding direction of the unwinder in the subsequent process is an upward direction (clockwise unwinding), the start portion S and the end portion E are inverted. In this case, the top side \textcircled{1} and the back side \textcircled{2} of the electrode sheet ES are not inverted.

When the winding direction of the rewinder in the preceding process is an upward direction and the unwinding direction of the unwinder in the subsequent process is a downward direction (counterclockwise unwinding), the inversion of the top side \textcircled{1} and the back side \textcircled{2} of the electrode sheet also occur simultaneously with the inversion of the start and end portions of the electrode sheet ES.

When the winding direction of the rewinder in the preceding process is a downward direction (counterclockwise unwinding) and the unwinding direction of the unwinder in the subsequent process is an upward direction, the inversion of the top side \textcircled{1} and the back side \textcircled{2} of the electrode sheet also occur simultaneously with the inversion of the start and end portions of the electrode sheet ES.

When the winding direction of the rewinder in the preceding process is a downward direction and the unwinding direction of the unwinder in the subsequent process is a downward direction, only the inversion of the start and end portions of the electrode sheet occurs.

The bottom in FIG. 6 shows whether start-to-end inversion and surface inversion occur depending on the winding direction or the unwinding direction when going through the first process, the second process, and the third process.

As shown in FIG. 5, even when the pattern indicator data is matched according to the start-to-end inversion of the electrode and electrode loss, when the surface inversion occurs as shown in FIG. 6, the pattern indicator data for each process may not match so as to correspond to the position of the same physical electrode sheet.

In this case, for example, the server of the server system may assign a control logic of 0 or 1, record whether the surface is inverted, and make the surfaces of the electrode sheets are matched with each other between the preceding and subsequent processes. That is, when surface inversion does not occur in FIG. 6, a control logic of 0 may be assigned. In this case, since surface inversion did not occur, the pattern indicator data in the preceding and subsequent processes may be matched through the corresponding operation as shown in FIG. 5.

When surface inversion occurs, a control logic of 1 may be assigned. In this case, the server may assign the pattern indicator data for each process on the basis of the control logic so that the absolute and relative pattern indicator data regarding the top side of the first process are matched with the absolute and relative pattern indicator data regarding the back side of the second process.

### Second Embodiment

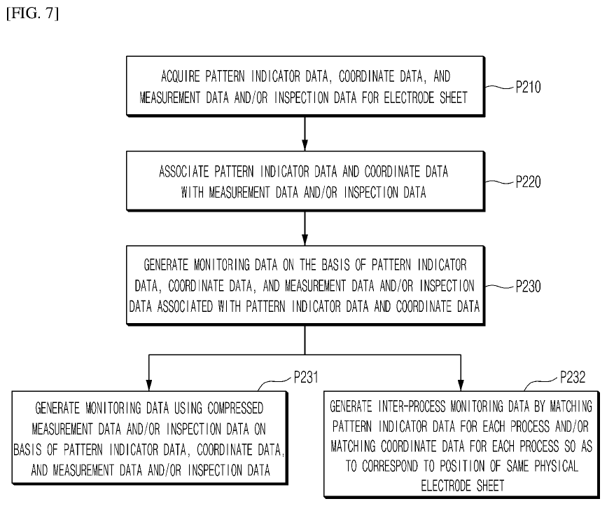

FIG. 7 is a flowchart for describing a battery manufacturing method according to another exemplary embodiment of the present disclosure.

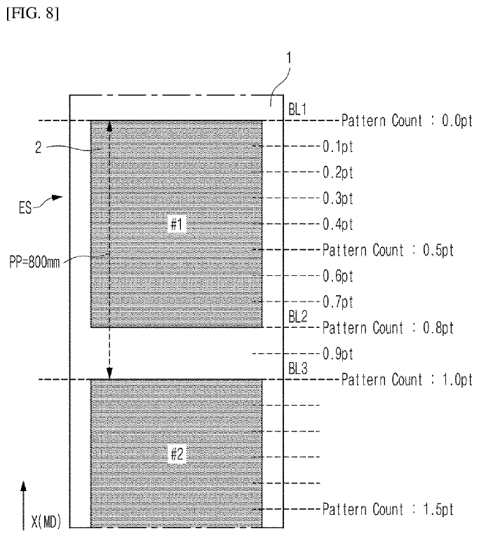

FIG. 8 illustrates a roll map of a patterned electrode on which pattern indicators and sub-pattern indicators are displayed according to an exemplary embodiment of the present disclosure.

Referring to FIG. 7, the battery manufacturing method of the present disclosure includes, in addition to acquiring pattern indicator data and measurement data and/or inspection data for an electrode sheet when the electrode sheet moves in a plurality of processes, an operation P210 of acquiring coordinate data that may indicate longitudinal positions of the electrode sheet in succession.

A method was previously described that calculates, using a calculation tool, a length (pitch) of a pattern or a length of a section in which the measurement data and/or inspection data are acquired using a moving speed of the electrode sheet or a time difference. This method may require that the moving speed of the electrode sheet be kept fairly constant, otherwise, a time point at which specific data is measured on the electrode sheet and a position of the electrode sheet at that time point may not be matched accurately. Further, the moving speed of the electrode sheet may vary depending on the standard of the electrode sheet, a type of a model, a type of a processing process, a driving mechanism of a processing device, etc. A method will be described below that does not indirectly determine a position of the electrode sheet or a distance using movement speed and time difference, which may reduce the amount of data processing.

In the embodiment of FIG. 7, pattern indicator data and coordinate data may be used together to display the longitudinal position of the electrode sheet. For example, pattern indicator data containing pattern indicators that intermittently indicate the positions on the electrode sheet may be acquired as main position data, and at the same time, coordinate data containing coordinate values that may indicate the longitudinal positions in succession may be further acquired. The coordinate values and differences between the coordinate values directly indicate the position of the electrode sheet or a distance of a specific section. Therefore, by acquiring the coordinate data, it may be possible to acquire position information about the electrode sheet without performing the additional calculations described above and by excluding the influence of the moving speed of the electrode sheet. By associating the coordinate data with the pattern indicator data, with the measurement data and/or inspection data, or with the measurement data and/or inspection data associated with the pattern indicator data, state information about the electrode sheet may be acquired more quickly.

A first position measuring instrument (pattern counter) may be used to acquire the pattern indicator data. A second position measuring instrument may be additionally used to acquire the coordinate data. The second position measuring instrument may be rotary encoders that may represent the position signal of the electrode sheet moving according to the rotation amount of the unwinder or rewinder as an encoder value. Alternatively, the second position measuring instrument may be a linear encoder that represents a position signal corresponding to the moving displacement of the electrode sheet as an encoder value. The encoders may be configured in contact or non-contact with the electrode sheet. The second position measuring instrument may be equipped with a predetermined calculation unit to convert the encoder value into the coordinate value. Alternatively, the process controller may receive the encoder value and convert the encoder value into the coordinate value through a predetermined operation. In consideration of the load on the process controller, the encoders may directly convert the encoder value into the coordinate value.

By comparing the set pattern pitch with the coordinate data, sub-pattern indicators obtained by further subdividing the pattern indicators may be calculated. For example, the pattern indicators and sub-pattern indicators may be pattern numbers and sub-pattern numbers, respectively, which will be used in FIG. 8, as an example.

Referring to FIG. 8, an electrode sheet ES having patterns moves in a longitudinal direction X, which is a moving direction MD.

For example, the first position measuring instrument, which is a pattern counter, may detect boundary lines BL1, BL2, and BL3 of coated portions 2 and uncoated portions 1. For example, the second position measuring instrument, which is a rotary encoder, may indicate a longitudinal position of each of patterns #1 and #2 as a coordinate value on the basis of the encoder value. In this case, when the set pattern pitch PP is 800 mm, the set pattern pitch may be divided into 10 equal parts and the pattern number may be displayed in decimal units. For example, when the electrode sheet moves by 80 mm and the controller receives the coordinate value corresponding to 80 mm, the controller may count a pattern number of 0.1 pt at a position corresponding to the coordinate value. Until the electrode sheet moves by 800 mm and the first position measuring instrument detects the boundary line BL3 of the coated portion of pattern number #2, the controller may count the sub-pattern number from 0.1 pt to 1.0 pt to correspond to the coordinate value of each point. As described above, by comparing the set pattern pitch with the coordinate data to calculate the sub-pattern number, the pattern number may be displayed in more detail. Accordingly, a pattern with an abnormal pitch may be more easily determined.

By comparing the set pattern pitch with the length of each pattern, a pattern with an abnormal pitch may be determined.

In this case, the length of each pattern and/or the lengths of the coated portion and the uncoated portion included in the pattern may be determined based on a difference in coordinate values between starting and ending points of each pattern, a difference in coordinate values between starting and ending points of the coated portion, and a difference in coordinate values between starting and ending points of the uncoated portion. In this case, since the coordinate values directly indicating the position and distance are compared with the pattern pitch, the length (pitch) of the pattern may be intuitively obtained without a separate calculation to calculate the distance (length) as in the first example. Therefore, it may be possible to more rapidly identify patterns of over- or under-pitch.

Referring to FIG. 7, the battery manufacturing method of the present disclosure includes, in addition to associating the pattern indicator data with the measurement data and/or inspection data, an operation P220 of associating the coordinate data with the pattern indicator data and the measurement data and/or inspection data.

As described with respect to the first example, the pattern indicator data and the measurement data and/or inspection data may be associated with each other based on the same time or time section. In the second example, in addition, the coordinate data may be associated with at least one of the following:
i) the pattern indicator data;
ii) the measurement data and/or inspection data; and
iii) the time or the time section at which the pattern indicator data and the measurement data and/or inspection data are acquired.

The battery manufacturing method of the present disclosure includes an operation P230 of generating monitoring data for battery manufacturing on the basis of the pattern indicator data, the coordinate data, and the measurement data and/or inspection data associated with the pattern indicator data and coordinate data.

As the monitoring data, a roll map including the coordinate data may be provided.

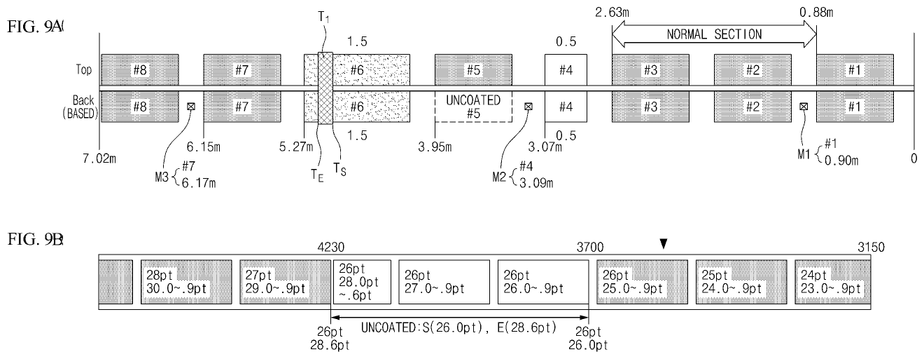

FIGS. 9A and 9B show an example of a roll map in which pattern indicator data and coordinate data are displayed on a patterned electrode according to an exemplary embodiment of the present disclosure.

FIG. 9A shows a roll map of a double-sided electrode simulating a coating state of a physical patterned electrode. A portion other than a coated portion on an electrode sheet is an uncoated portion.

In the present example, a first uncoated portion on the right side of FIG. 9A and a coated portion adjacent thereto may be combined and counted as a pattern of pattern number #1. Alternatively, a first coated portion on the right side of FIG. 9A and an uncoated portion on the left side adjacent thereto may be combined and counted as a pattern of pattern number #1. A first position measuring instrument sequentially detects boundary lines between the uncoated portions and the coated portions, detects patterns of pattern numbers #1 to #8, and acquires pattern indicator data. Coordinate data (expressed in m units) acquired by a second position measuring instrument is displayed on the roll map. In order to avoid data overload, the coordinate data may be displayed on major portions of the roll map.

The roll map may be generated not only for a single-sided electrode with coated portions formed on only one side of the electrode sheet, but also for a double-sided electrode with coated portions formed on both sides of the electrode sheet as shown FIG. 9A. In order to prevent excessive growth of roll map data, major event information may be collected and transmitted to the server. The server may generate a roll map for the double-sided electrode on the basis of the major event information. When performance management is performed according to both upper and lower surface patterns, the amount of data to be considered increases, and thus performance management may be performed based on any one pattern of the upper and lower surface patterns. In the present embodiment, pattern performance management may be performed based on the lower surface pattern.

When a set pattern pitch is set to 878 mm, a pattern with an abnormal pitch may be displayed by comparing the set pattern pitch with the coordinate data on the basis of the pattern indicator data acquired by the first position measuring instrument and the coordinate data acquired by the second position measuring instrument. FIG. 9A shows a normal section coated according to the set pattern pitch. However, based on the back side pattern, an under-length pattern is measured and displayed at pattern number #4, an uncoated section is measured at pattern number #5, and an excessive-length pattern is measured and displayed at pattern number #6. For example, a pattern that is 0.5 times or less than the set pattern pitch may be regarded as a defective pattern. Alternatively, a pattern that is 1.5 times or more than the set pattern pitch may be regarded as a defective pattern.

When an uncoated section not included in the pattern is present between neighboring patterns, pattern indicators may be assigned to uncoated sections equal to the number of patterns obtained by dividing the length of the uncoated section by the set pattern pitch. In FIG. 9A, pattern number #5 is assigned to an uncoated section between patterns of pattern numbers #4 and #6. When the pattern indicator is not assigned to the uncoated section, there may be a gap in the roll map information and the state of the electrode sheet may not be completely expressed. When managing and tracking electrode processes with these roll maps, errors may occur. Therefore, the roll map should include information about the uncoated section not included in the pattern, together with information about the pattern with an abnormal pitch that is different from the set pattern pitch. The information about the uncoated section is information about pattern indicators assigned to the uncoated section corresponding to the number of patterns obtained by dividing by the set pattern pitch.

In the present embodiment, information about reference points and seams is also included.

Reference points M1, M2, and M3 are marked on the electrode sheet at predetermined intervals. Actual positions of the reference points may be measured and the positions of the reference point and the intervals may be displayed on the roll map. When the intervals between the reference points change from a set reference point position, changes in electrode length that occur during the process or before and after the process may be identified. A mark on connecting tape, which is a seam, may mean that the electrode is broken for some reason and is connected by the connecting tape T₁. The position of the connecting tape T₁ may be indicated by acquiring coordinate values or pattern indicator data regarding a starting point Ts and an end point Te of the connecting tape. From this information, it may be possible to more accurately determine the history of changes in the state of the physical electrode sheet that has gone through a plurality of processes.

In FIG. 9A, three reference points M1, M2, and M3 are displayed and pattern indicators and coordinate values for each reference point are shown. The reference points may be measured by a reference point measuring instrument, and the seams may be measured by a seam sensor.

FIG. 9B is a roll map in which pattern indicator data and coordinate data are marked between a coated section and an uncoated section. For example, the pattern indicators and sub-pattern indicators may be pattern numbers and sub-pattern numbers, respectively, which will be used in FIG. 9B, as an example.

In FIG. 9B, the pattern number is displayed in sub-pattern number units.

Further, the coordinate values are displayed at key points.

There is an uncoated section in a roll map of FIG. 9B, and a sub-pattern number is displayed for the uncoated section in comparison with the set pattern pitch. The uncoated section includes an uncoated portion corresponding to two set pattern pitches and an uncoated portion corresponding to 0.6 times (0.6 pt) the set pattern pitch.

Meanwhile, only information about performance excluding the uncoated section may be collected and transmitted to the process controller. The controller is a process facility that controls the process, processes the performance of physical electrodes, and records the performance. Among the pattern numbers in FIG. 9B, those that are not sub-pattern numbers (numbers not expressed in decimal units: for example, 24 pt) are pattern numbers indicating performance. In the uncoated section, the pattern number remains unchanged at 26 pt, and at the point where the uncoated section ends, the pattern number becomes 27 pt, increasing the pattern number by 1.

In this way, according to the present disclosure, using the battery manufacturing system described above, the pattern indicator data and the coordinate data may be freely displayed, and furthermore, the pattern indicators that are counted as performance and pattern indicators that are not performance may be displayed separately.

Therefore, monitoring data and roll map data that match the state of the physical patterned electrode may be generated, and thus data match may be significantly improved.

Referring to FIG. 7, the battery manufacturing method of the present embodiment includes, when the monitoring data is generated, at least one of the following operations:
i) an operation P231 of generating the monitoring data using compressed measurement data and/or inspection data on the basis of the pattern indicator data, the coordinate data, and the measurement data and/or inspection data; and
ii) an operation P232 of generating inter-process monitoring data by matching the pattern indicator data for each process and/or matching the coordinate data for each process so as to correspond to the position of the same physical electrode sheet.

In the present embodiment, the measurement data and/or inspection data may be compressed based on the coordinate data in addition to the pattern indicator data. That is, a representative value may be calculated by compressing a plurality of measurement values measured for one pattern or a plurality of patterns. In this case, the coordinate data having coordinate values corresponding to the one pattern or plurality of patterns may also be included in the compressed data.

For example, a processing unit provided in the measuring instrument and/or inspecting instrument may be configured to generate the compressed measurement data and/or inspection data on the basis of the pattern indicator data, the coordinate data, and the measurement data and/or inspection data.

The compressed measurement data and/or inspection data may include a representative value of measurement values and/or inspection values of the measurement data and/or inspection data, and pattern indicator data and coordinate data for starting and ending points of a portion of the electrode sheet in which the measurement data and/or inspection data are collected.

The representative value may include at least one of an average, a standard deviation, a median, a maximum value, and a minimum value of the measurement data and/or inspection data of each pattern.

Pattern indicators and coordinate values of the starting and ending points of each pattern of the electrode sheet in which the measurement data and/or inspection data are collected may be determined based on the pattern indicator data and the coordinate data. Alternatively, pattern indicators and coordinate values of the starting and ending points of a portion of the electrode sheet corresponding to the plurality of patterns grouped by group may be determined.

The measurement data and/or inspection data are processed according to a set method, and thus the determination values for each pattern or plurality of patterns of the electrode sheet may be determined.

The processing unit may be configured to transmit the compressed measurement data and/or inspection data to the server system directly or through the process controller.

The server system or the server included in the server system may generate monitoring data (e.g., roll map) including the compressed measurement data and/or inspection data.

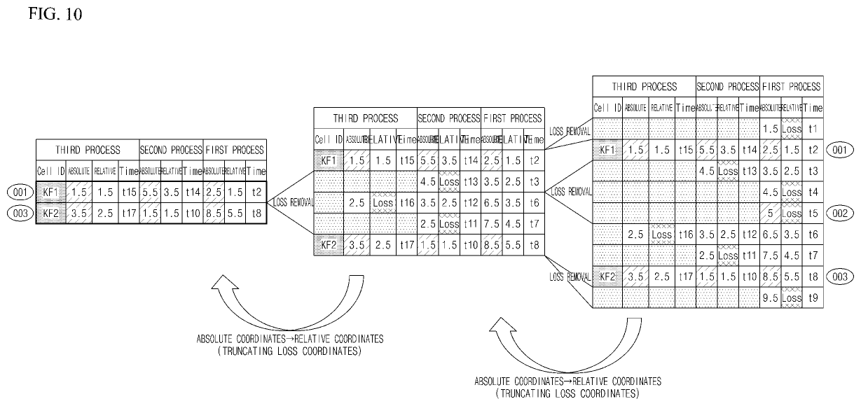

FIG. 10 shows inter-process monitoring data generated by a battery manufacturing method according to an exemplary embodiment of the present disclosure.

The monitoring data may include a roll map for each process, which includes pattern indicator data for each process, coordinate data, and measurement data and/or inspection data for each process associated with the pattern indicator data.

Alternatively, the monitoring data may be inter-process monitoring data by matching the pattern indicator data for each process and the coordinate data so as to correspond to the position of the same physical electrode sheet.

In FIG. 10, changes in coordinate data of first to third processes are shown together with time data.

In electrodes with coordinate values of 1.5 to 9.5 in the first process, the coordinate values are arranged in inverted order in the second process. Further, the coordinate values in the second process are arranged in inverted order in the third process. Since the positions of the start and end portions of the electrode sheet are inverted between the processes, in order to compare the data of each process at the position of the same physical electrode sheet, it may be necessary to perform matching the inverted pattern number data as shown in FIG. 10.

Further, FIG. 10 shows the portions removed in each process. When the coordinate data is shown including the portion removed due to loss in each process, it is indicated as “absolute,” and when the coordinate data is shown excluding the removed portion, it is indicated as “relative.” The coordinate data may indicate longitudinal positions of the electrode sheet in succession, for example, according to a pulse value of a rotary encoder. On the other hand, the pattern indicator data may be advantageous for intermittently indicating the positions of the electrode sheet. For example, the pattern indicator data may be expressed as a sub-pattern number of 0.1 units. For example, the coordinate data may be expressed in units of 0.01 m.

For example, in the first process, only coordinate values 2.5, 3.5, 6.5, 7.5, and 8.5 among “absolute coordinate values” 1.5 to 9.5 remain in consideration of the loss that occurs during the process. When this data is corrected with “relative coordinate values,” it becomes 1.5 to 5.5. That is, “absolute coordinate value” 2.5 in the first process corresponds to “relative coordinate value” of 1.5. These coordinate values are acquired at the same time t2. By reflecting the loss in each process and considering the inversion of the start and end portions between the processes, the coordinate data corresponding to the position of the same physical electrode sheet may be matched in each process.

Cell IDs KF1 and KF2 may be assigned to battery cells manufactured from the surviving electrodes that are finally remaining through the first to third processes. In this case, the coordinate data for each process corresponding to each cell ID is the same as shown in the leftmost diagram of FIG. 10.

Further, inter-process monitoring data of FIG. 10 may be generated according to the surface inversion described above.

When surface inversion does not occur, a control logic 0 may be assigned. In this case, since the surface inversion did not occur, the coordinate data of the preceding and subsequent processes may be matched through the corresponding operation as shown in FIG. 10.

When surface inversion occurs, a control logic 1 may be assigned. In this case, the server may assign the coordinate data for each process on the basis of the control logic so that the absolute and relative coordinate data regarding the top side of the first process are matched with the absolute and relative coordinate data regarding the back side of the second process.

In FIG. 10, only inter-process correspondence of the coordinate data is shown, but matching between the processes may also be performed with the pattern indicator data associated with the coordinate data. That is, the pattern indicator data of each process may be matched and/or the coordinate data of each process may be matched, by at least one of the following:
1) as positions of start and end portions of the electrode sheet are inverted between the processes, matching between the processes is performed with the inverted pattern indicator data and/or coordinate data;
2) matching between the processes is performed with the pattern indicator data and/or the coordinate data which changes depending on the loss of the electrode sheet that occurs during each process and/or between the processes; and
3) as a corresponding surface of the electrode sheet is inverted between the processes in a winding direction or an unwinding direction of the electrode sheet, matching between the processes is performed with the inverted pattern indicator data and/or coordinate data.

The pattern indicator data for each process and the coordinate data are associated with the measurement data and/or inspection data. Therefore, by referring to the roll map or data included in the roll map, when a specific pattern indicator and coordinate value are selected, the measurement data and/or inspection data corresponding to the values may be identified.

### Third Embodiment

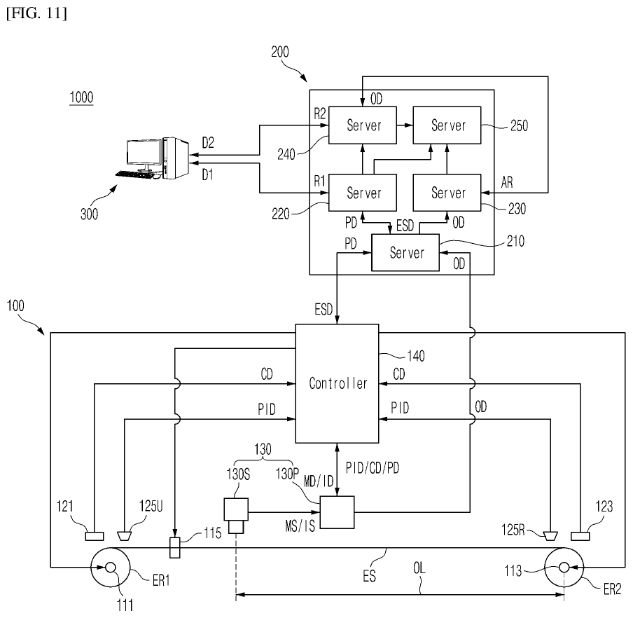

FIG. 11 illustrates a battery manufacturing system according to yet another exemplary embodiment of the present disclosure.

A battery manufacturing system 1000 may include a battery manufacturing device 100, a server system 200, and a user device 300.

The battery manufacturing device 100 may include an unwinder 111, a rewinder 113, a processing mechanism 115, first position measuring instruments 125R and 125U, second position measuring instruments 121 and 123, a measuring instrument and/or inspecting instrument 130, and a controller 140.

The unwinder 111 may be configured to unwind an electrode sheet ES from an electrode roll ER1. The rewinder 113 may be configured to wind the electrode sheet ES onto an electrode roll ER2. Accordingly, the electrode sheet ES may move between the unwinder 111 and the rewinder 113.

A process (e.g., electrode process) for battery manufacturing may be performed on the electrode sheet ES.

The electrode sheet ES may be processed by the processing mechanism 115. As an example, the processing mechanism 115 may include a coater, and may apply an electrode slurry on the electrode sheet to form a patterned electrode sheet. As another example, the processing mechanism 115 may include a pressing roll, and a roll pressing process may be performed on the electrode sheet ES coated with the electrode slurry in a pattern shape. As still another example, the processing mechanism 115 may include a splicing die and a scrap pot, and a portion of the electrode sheet ES may be scrapped. As yet another example, the processing mechanism may include a slitting knife, and the electrode sheet ES may be divided into a plurality of electrode sheets.

The first position measuring instruments 125R and 125U may be pattern counters that count pattern indicators on electrodes. The pattern indicators intermittently indicate positions on the electrode sheet moving between the unwinder and the rewinder.

The first position measuring instrument 125U installed on the unwinder side may be configured to detect the amount of the electrode sheet ES unwounded from the electrode roll ER1 by the unwinder 111. The controller 140 may be configured to collect pattern indicator data PND generated by the first position measuring instrument 125U.

The first position measuring instrument 125R installed on the rewinder side may be configured to detect the amount of the electrode sheet ES wound onto the patterned electrode roll ER2 by the rewinder 113. The controller 140 may be configured to collect pattern indicator data PID generated by the first position measuring instrument 125R. The pattern indicator data PID may indicate the production result of the battery manufacturing device 100.

The second position measuring instrument may be, for example, a rotary encoder. A first rotary encoder 121 of the second position measuring instrument may be configured to detect the amount of the electrode sheet ES unwounded from the electrode roll ER1 by the unwinder 111. Accordingly, the first rotary encoder 121 may be configured to generate an unwinding amount signal indicating an unwinding amount of the electrode sheet ES. The first rotary encoder 121 may directly acquire input amount data (coordinate data) by converting the unwinding amount signal. Alternatively, the first rotary encoder 121 may transmit the unwinding amount signal to the controller 140, and the controller 140 may convert the signal to collect the input amount data. The input amount data is the amount of material (i.e., electrode roll ER1) input into the battery manufacturing device 100 to manufacture a battery, and is coordinate data CD.

A second rotary encoder 123 may be configured to detect the amount of the electrode sheet ES wound onto the electrode roll ER2 by the rewinder 113. Accordingly, the second rotary encoder 123 may be configured to generate a winding amount signal indicating a winding amount of the electrode sheet ES. The second rotary encoder 123 may convert the winding amount signal to directly acquire consumption amount data (coordinate data). Alternatively, the second rotary encoder 123 may transmit the winding amount signal to the controller 140, and the controller 140 may convert the signal to collect the consumption amount data. The consumption amount data may indicate the production result of the battery manufacturing device 100.

Hereinafter, the technical spirit of the present disclosure will be described by being focused on an example in which the controller 140 collects pattern indicator data PID and coordinate data CD generated by the first position measuring instrument 125R and the second position measuring instrument 123.

As a non-limiting example, the controller 140 is a process controller that controls the processing process and may be a Programmable Logic Controller (PLC). The controller 140 may include a power supply, a central processing unit (CPU), an input interface, an output interface, a communication interface, and memory devices. The communication interface may be configured to perform transmission or reception of data between the controller 140 and the first position measuring instruments 125U and 125R, the second position measuring instruments 121 and 123, the measuring instrument and/or inspecting instrument 130, and the server system 200.

The measuring instrument may be configured to collect measurement data MD by measuring the electrode sheet ES. The inspecting instrument may be configured to collect inspection data ID by inspecting the electrode sheet ES. One or more measuring instruments or the inspecting instruments may be provided. In the present embodiment, for convenience of description, the measuring instrument and/or inspecting instrument are combined and indicated by one reference numeral 130.

The measuring instrument and/or inspecting instrument may include a sensing unit 130S and a processing unit 130P. The sensing unit 130S may be configured to detect a physical quantity of the electrode sheet ES to generate a measurement signal MS or an inspection signal IS. For example, the sensing unit 130S may include a time delay and Integration (TDI) camera, a complementary metal oxide semiconductor (CMOS) image sensor, a time of flight (TOF) sensor, etc.

The processing unit 130P may be configured to receive the measurement signal MS or inspection signal IS detected by the sensing unit 130S to collect the measurement data MD of the inspection data ID. The processing unit 130P may be connected to the sensing unit 130S in a wired or wireless manner.

The controller 140 may collect the measurement data and/or inspection data MD/ID generated by the measuring instrument and/or inspecting instrument 130. Further, the controller 140 may be configured to control the operations of the unwinder 111, the rewinder 113, and the processing mechanism 115. Signals for activating and stopping the unwinder 111, the rewinder 113, and the processing mechanism 115 may be generated based on electrode specification data (ESD), additional inspection signals, and measurement signals.

Pattern indicators of the pattern indicator data PID may be associated with the measurement data and/or inspection data MD/ID. For example, the pattern indicators collected based on a specific time or time section may be associated with the measurement data and/or inspection data MD/ID matching the same time or time section. The processing unit 130P of the measuring instrument and/or inspecting instrument may receive the pattern indicator data PID from the first position measuring instruments 125U and 125R and associate the pattern indicators with the measurement data and/or inspection data. Alternatively, the pattern indicator data and the measurement data and/or inspection data may be transmitted to the controller 140 so that the pattern indicators may be associated with the measurement data and/or inspection data in the controller.

Further, the processing unit 130P of the measuring instrument and/or inspecting instrument may receive the coordinate data CD from the second position measuring instruments 121 and 123 and associate the coordinate data with the pattern indicator data and the measurement data and/or inspection data. Alternatively, the coordinate data and the measurement data and/or inspection data may be transmitted to the controller 140 so that the coordinate data may be associated with the pattern indicator data and the measurement data and/or inspection data in the controller.

According to an exemplary embodiment, the measuring instrument and/or inspecting instrument 130 or the controller 140 may correct the pattern indicator data PID and the coordinate data CD on the basis of an offset length OL. For example, the pattern indicators and sub-pattern indicators may be pattern numbers and sub-pattern numbers, respectively, which will be used as an example below.

Since the positions of the measuring instrument and/or inspecting instrument and the first position measuring instrument are different, a portion of the electrode sheet ES that is measured and/or inspected and a portion of the electrode sheet ES that is a target of the pattern number detected by the first position measuring instrument may be different at the same time point. Likewise, since the positions of the measuring instrument and/or inspecting instrument and the second position measuring instrument are different, a portion of the electrode sheet ES that is measured and/or inspected and a portion of the electrode sheet that is a target of the pattern number detected by the second position measuring instrument may be different at the same time point.

Therefore, the pattern number may be corrected by adding or subtracting the number of pattern numbers corresponding to the offset length to or from the pattern number of the pattern number data collected at the same time as the measurement data and/or inspection data, and the measurement data and/or inspection data associated with the corrected pattern numbers may be acquired by associating the corrected pattern number with the measurement data and/or inspection data. Further, the coordinate values may be corrected by adding or subtracting the offset length to or from the coordinate values of the coordinate data collected at the same time as the measurement data and/or inspection data, and the measurement data and/or inspection data associated with the corrected coordinate data may be acquired by associating the corrected coordinate values with the measurement data and/or inspection data.

The correction of the pattern number data and/or coordinate data may be performed by the processing unit 130P of the measuring instrument and/or inspecting instrument, or the controller 140.

The measurement data and/or inspection data associated with the pattern indicator data generated by the processing unit 130P may be transmitted to the server system 200 directly or through the controller 140. Alternatively, the measurement data and/or inspection data associated with the pattern indicator data generated by the controller 140 may be transmitted to the server system 200.

The measurement data and/or inspection data associated with the coordinate data generated by the processing unit 130P may be transmitted to the server system 200 directly or through the controller 140. Alternatively, the measurement data and/or inspection data associated with the coordinate data generated by the controller 140 may be transmitted to the server system 200.

The server system 200 may generate monitoring data for battery manufacturing on the basis of the pattern indicator data PID, and the measurement data and/or inspection data associated with the pattern indicator data.

Alternatively, the server system 200 may generate monitoring data for battery manufacturing on the basis of the pattern indicator data PID, the coordinate data CD, and the measurement data and/or inspection data associated with the pattern indicator data and coordinate data.

The server system may generate at least one of the following monitoring data:
i) monitoring data including compressed measurement data and/or inspection data on the basis of the pattern indicator data PID and the measurement data and/or inspection data; and
ii) inter-process monitoring data generated by matching the pattern indicator data for each process so as to correspond to a position of the same physical electrode sheet.

Further, the server system may generate at least one of the following monitoring data:
i) the monitoring data including compressed measurement data and/or inspection data on the basis of the pattern indicator data PID, the coordinate data CD, and the measurement data and/or inspection data; and
ii) the inter-process monitoring data generated by matching the pattern indicator data for each process and/or matching the coordinate data for each process so as to correspond to the position of the same physical electrode sheet.

The processing unit 130P of the measuring instrument and/or inspecting instrument 130 may be configured to generate the compressed measurement data and/or inspection data on the basis of the pattern indicator data and the measurement data and/or inspection data. Alternatively, the processing unit 130P of the measuring instrument and/or inspecting instrument 130 may be configured to generate the compressed measurement data and/or inspection data on the basis of the pattern indicator data, the coordinate data, and the measurement data and/or inspection data. The compressed measurement data and/or inspection data may include a representative value of measurement values and/or inspection values of the measurement data and/or inspection data, and pattern indicator data and coordinate data for starting and ending points of a portion of the electrode sheet in which the measurement data and/or inspection data are collected.

Original data OD (pattern indicator data, coordinate data, and measurement data and/or inspection data associated with pattern indicator data and coordinate data) acquired by the processing unit 130P and the compressed measurement data and/or inspection data PD may be transmitted to the server system 200 through different paths.

For example, the compressed measurement data and/or inspection data PD may be transmitted from the processing unit 130P to the server system 200 through the controller 140. The original data OD may be directly transmitted from the processing unit 130P to the server system 200.

The server system 200 may include a plurality of servers 210, 220, 230, 240, and 250 to perform each function.

The compressed measurement data and/or inspection data PD may be transmitted to the server 220 via the server 210 within the server system 200. The server 210 may be a program for communication between the process controller 140 of a manufacturing facility and the server 220 for manufacturing management. The server 210 may be implemented in hardware. The server 210 may be configured to convert the electrode specification data ESD transmitted from the server 220 into the language of the controller 140. Further, the server 210 may be configured to convert the compressed measurement data and/or inspection data PD into the language of the server 220 and record the compressed measurement data and/or inspection data PD in a database of the server 220.

The server 220 may be configured to generate a roll map. The roll map may include data regarding specifications of a lot. The specifications of the lot may include, for example, a lot number, a length of the wound electrode sheet ES, a width of the electrode sheet ES, and materials and compositions used in processing the electrode sheet ES.

According to the exemplary embodiments, the server 220 may be a data processing system that supports all activities necessary to manage the manufacturing of secondary batteries, such as work schedule management, work instructions, quality control, and work performance tally. The server 220 may be, for example, a manufacturing execution system (MES). The server 220 may be configured to perform input, processing, output, and communication of data required for electrode manufacturing processes such as a coating process, a roll pressing process, and a slitting process.

The server 230 may be configured to store large-sized original data OD, that is, original data OD including raw data. The server 230 may be configured to transmit the original data OD to the server 240 in response to an application programming interface (API) request AR of the server 240. The API request AR may include information for identifying measurement data and/or inspection data associated with pattern number data and/or the coordinate data. The API request AR may include, for example, a timestamp, a start pattern indicator, an end pattern indicator, a start coordinate, and an end coordinate.

The server 240 may be configured to store and process measurement data and/or inspection data of the electrode sheet ES. The server 240 may manage the quality of processing of the electrode sheet ES by continuously monitoring the processing of the electrode sheet ES on the basis of the measurement data and/or inspection data. According to the exemplary embodiments of, the server 240 may be a statistical process controller (SPC). By collecting and analyzing manufacturing data in near real time, the server 240 may identify problem conditions in a timely manner and provide alerts to operators before potential problems occur.

The server 250 may be configured to store data of the servers 220, 230, and 240. The server 250 may be configured to store the original data OD and the compressed data PD. The server 250 may be, for example, a data warehouse and may store necessary data for a long period of time on the basis of the quality warranty period of a product, etc. Accordingly, tracking of the manufacturing process according to the product life cycle may be provided.

Since the server 220 stores and processes a large amount of data regarding general manufacturing management other than the roll map, the roll map stored in the server 220 may include small-sized compressed data PD instead of large-sized original data. The server 220 may provide a roll map in response to a request from the user device 300.

The server 240 may provide a roll map including the original data OD. Further, as described with reference to FIGS. 5, 6, and 10, the server 240 may generate inter-process monitoring data in which the pattern indicator data for each process is displayed to be matched with each other so as to correspond to the position of the same physical electrode sheet. Further, the server 240 may generate inter-process monitoring data in which coordinate data of each process is displayed to be matched with each other so as to correspond to the position of the same physical electrode sheet.

That is, the server 240 may calculate pattern indicator data and coordinate data corresponding to the position of the physical electrode sheet in consideration of the start-to-end inversion of the electrode and electrode loss between the plurality of processes on the basis of the time or time section of the electrode sheet (see FIGS. 5 and 10). Further, the server 240 may determine whether the surface is inverted between the preceding process and the subsequent process and correspond to the pattern indicator data and coordinate data of the preceding process and the subsequent process, respectively, so that the surfaces of the electrode sheets correspond. In this case, the server 240 may assign a control logic 0 or 1 to the monitoring data (e.g., roll map) of each process depending on whether the surface is inverted. The server 240 may be equipped with a separate or integrated calculation unit or calculation programs that rearrange, calculate, and correspond to data according to the start-to-end inversion of the electrode, electrode loss, and electrode surface inversion.

The server 240 may generate an overlay roll map in which the pattern indicator data and coordinate data of the roll map of each process are respectively corrected to the same value on the basis of the inter-process monitoring data to which each piece of data corresponds. The overlay roll map may allow intuitive understanding of the plurality of processes and may be said to be an intermediate roll map that is one step more advanced than a normal roll map.

The user device 300 may display a visualized roll map (VRM). The user device 300 may be any device for communicating with the server system 200, such as a workstation computer, a notebook computer, a laptop computer, a desktop computer, a tablet computer, a mobile device such as a smart phone, or a wearable device. The user device 300 may be configured to generate a request R1 for loading a roll map or a request R2 for loading an intermediate roll map. The user device 300 may be configured to transmit the requests R1 and R2 to the server system 200. The user device 300 may include input tools for inputting the requests R1 and R2 and a display device for displaying a visualized roll map (VRM).

The servers 210, 220, 230, 240, and 250 may include physical servers or cloud servers. The servers 210, 220, 230, 240, and 250 may include various application programming interfaces (APIs) for storing data in databases and other data management tools.

The server, controller, device, unit, etc., disclosed in connection with various embodiments and the various elements therein comprised, which enable the implementation of methods and processes in accordance with the present disclosure, may be implemented by one or more processors having circuitry, such as one or more microprocessors executing software or firmware, and/or one or more application specific integrated circuits (ASICs), and/or a combination of ASICs, discrete electronic components (e.g., transistors), and microprocessors. In some embodiments, components shown as separate may be replaced by a single component. In addition, some of the components displayed may be additional, or may be replaced by other components.

In various embodiments, one or more memories may store a set of instructions that may be executed to cause one or more processors to perform any one or more of the methods or processes based on functionality disclosed in the present disclosure. The one or more memories may communicate via one or more electrical wires or buses or wirelessly. The one or more memories may be a static memory, or a dynamic memory. The one or more memories may include, but not limited to computer readable storage media such as various types of volatile and non-volatile storage media, including but not limited to random access memory, read-only memory, programmable read-only memory, electrically programmable read-only memory, electrically erasable read-only memory, flash memory, and the like. In one implementation, the one or more memories may include a cache or random-access memory for one or more processors. The one or more memories may be a cache memory of one or more processors, the system memory, or other memory. Processing strategies may include multiprocessing, multitasking, and the like. The computer readable storage media described in connection with the one or more memories in accordance with the various embodiments may be non-transitory, and may be tangible.

The present disclosure has been described above in more detail through the drawings and examples. However, since the embodiments described in this specification and configurations illustrated in drawings are only exemplary embodiments and do not represent the overall technological scope of the present disclosure, it is understood that the present disclosure covers various equivalents and modifications that are substitutable at the time of filing of this application.

What is claimed is:

1. A method of manufacturing a battery, comprising:
a first operation of acquiring pattern indicator data and measurement data and/or inspection data for an electrode sheet having patterns in which coated portions and uncoated portion are repeatedly arranged, and the pattern indicator data includes representing positions of the patterns at the electrode sheet;
a second operation of associating the measurement data and/or inspection data with the pattern indicator data; and
a third operation of generating inter-process monitoring data by matching the pattern indicator data for each process of a plurality of processes so as to correspond to a same physical position of the electrode sheet.

2. The method of claim 1, wherein the pattern indicator data for each process is matched by at least one of the following:
operation 1 of matching between the processes with inverted pattern indicator data as positions of start and end portions of the electrode sheet are inverted between the processes;
operation 2 of matching between the processes with the inverted pattern indicator data as a corresponding surface of the electrode sheet is inverted between the processes in a winding direction or an unwinding direction of the electrode sheet; and
operation 3 of matching between the processes with the pattern indicator data which changes depending on a loss at the electrode sheet that occurs during a process and/or between the processes.

3. The method of claim 2, wherein, in a process, operation 3 comprises:
indicating the pattern indicator data as absolute for the pattern indicator data that includes at least one portion removed due to the loss from the electrode sheet;
indicating the pattern indicator data as relative for the pattern indicator data that excludes the at least one portion removed due to the loss from the electrode sheet; and
matching the relative pattern indicator data with the absolute pattern indicator data that does not include the at least one portion removed due to the loss from the electrode sheet.

4. The method of 3, comprises associating a cell ID to a relative pattern indicator data in a final process among the processes.

5. The method of claim 1, wherein:
the first operation includes acquiring coordinate data that indicates positions of the electrode sheet in succession;
the second operation includes associating the measurement data and/or inspection data with the pattern indicator data and the coordinate data; and
the third operation includes generating the monitoring data based on the pattern indicator data, the coordinate data, and the measurement data and/or inspection data associated with the pattern indicator data and the coordinate data.

6. The method of claim 5, wherein the third operation includes at least one of the following operations:
i) compressing the measurement data and/or inspection data based on the pattern indicator data, the coordinate data, and the measurement data and/or inspection data; and
ii) generating inter-process monitoring data by matching the pattern indicator data for each process and/or matching the coordinate data for each process so as to correspond to the same physical position of the electrode sheet.

7. The method of claim 6, wherein compressing the measurement data and/or inspection data includes at least one of calculating a representative value and/or determining a determination value for measurement values and/or inspection values of respective measurement data and/or inspection data collected for pattern indicator data and the coordinate data of starting and ending points of a portion of the electrode sheet.

8. The method of claim 6, wherein the pattern indicator data for each process is matched or the coordinate data for each process is matched, by at least one of the following:
1) matching between the processes with the inverted pattern indicator data as positions of start and end portions of the electrode sheet are inverted between the processes;
2) matching between the processes with the pattern indicator data and/or the coordinate data which changes depending on a loss at the electrode sheet that occurs during a process and/or between the processes; and
3) matching between the processes with the inverted pattern indicator data as a corresponding surface of the electrode sheet is inverted between the processes in a winding direction or an unwinding direction of the electrode sheet.

9. The method of claim 5, wherein the pattern indicator data, the coordinate data, and the measurement data and/or inspection data are associated with each other based on a same time or time section.

10. The method of claim 1, wherein the monitoring data includes at least one of:
a roll map for each process that includes the pattern indicator data for each process and the measurement data and/or inspection data for each process associated with the pattern indicator data; and
a roll map in which the pattern indicator data for each process is displayed to be matched with each other so as to correspond to the same physical position of the electrode sheet.

11. A battery manufacturing system comprising:
a first position measuring instrument configured to generate pattern indicator data representing positions of patterns on the electrode sheet in which coated portions and uncoated portion are repeatedly arranged;
a measuring instrument and/or an inspecting instrument configured to collect measurement data and/or inspection data for the electrode sheet; and
one or more processors configured to generate monitoring data for battery manufacturing based on the pattern indicator data and the measurement data and/or inspection data associated with the pattern indicator data,
wherein the one or more processors are configured to generate inter-process monitoring data by matching the pattern indicator data for each process of a plurality of processes so as to correspond to a same physical position of the electrode sheet.

12. The system of claim 11, wherein the one or more processors are configured to match the pattern indicator data for each process based on at least one of the following operations:
operation 1 of matching between the processes with inverted pattern indicator data as positions of start and end portions of the electrode sheet are inverted between the processes;
operation 2 of matching between the processes with the inverted pattern indicator data as a corresponding surface of the electrode sheet is inverted between the processes in a winding direction or an unwinding direction of the electrode sheet; and
operation 3 of matching between the processes with the pattern indicator data which changes depending on a loss at the electrode sheet that occurs during a process and/or between the processes.

13. The system of claim 12, wherein, in operation 3 in a process, the one or more processors are configured to:
indicate the pattern indicator data as absolute for the pattern indicator data that includes at least one portion removed due to the loss from the electrode sheet;
indicate the pattern indicator data as relative for the pattern indicator data that excludes the at least one portion removed due to the loss from the electrode sheet; and
match the relative pattern indicator data with the absolute pattern indicator data that does not include the at least one portion removed due to the loss from the electrode sheet.

14. The system of claim 13, wherein the one or more processors are configured to associate a cell ID to a relative pattern indicator data in a final process among the processes.

15. The system of claim 11, further comprising a second position measuring instrument configured to generate coordinate data that indicates positions of the electrode sheet in succession,
wherein the one or more processors are configured to:
generate the monitoring data for battery manufacturing based on the pattern indicator data, the coordinate data, and the measurement data and/or inspection data associated with the pattern indicator data and the coordinate data;
associate the measurement data and/or inspection data with the pattern indicator data and the coordinate data; and
generate the monitoring data based on the pattern indicator data, the coordinate data, and the measurement data and/or inspection data associated with the pattern indicator data and the coordinate data.

16. The system of claim 11, wherein the one or processors are configured to generate at least one of the following:
i) compressed measurement data and/or inspection data based on the pattern indicator data, the coordinate data, and the measurement data and/or inspection data; and
ii) inter-process monitoring data generated by matching the pattern indicator data for each process and/or matching the coordinate data for each process so as to correspond to the same physical position of the electrode sheet.

17. The system of claim 16, wherein the one or more processors are configured to generate the compressed measurement data and/or inspection data by at least one of calculating a representative value and/or determining a determination value for measurement values and/or inspection values of respective measurement data and/or inspection data collected for pattern indicator data and the coordinate data of starting and ending points of a portion of the electrode sheet.

18. The system of claim 12, wherein the one or more processors are configured to associate the pattern indicator data, the coordinate data, and the measurement data and/or inspection data with each other based on a same time or time section.

19. The system of claim 11, wherein the server system includes at least one of the following servers:
i) a roll map generation server that generates a roll map for each process including the pattern indicator data for each process and the measurement data and/or inspection data for each process associated with the pattern indicator data; and
ii) a roll map generation server that generates a roll map in which the pattern indicator data for each process is displayed to be matched with each other so as to correspond to a position of the same physical electrode sheet, as the inter-process monitoring data.

20. One or more non-transitory processor-readable mediums storing executable instructions therein, which when executed by one or more processors, causes the one or more processors to perform a method of manufacturing a battery, comprising:
acquiring pattern indicator data and measurement data and/or inspection data for an electrode sheet having patterns in which coated portions and uncoated portion are repeatedly arranged, and the pattern indicator data includes representing positions of the patterns at the electrode sheet;
associating the measurement data and/or inspection data with the pattern indicator data; and
generating inter-process monitoring data by matching the pattern indicator data for each process of a plurality of processes so as to correspond to a same physical position of the electrode sheet.
